(19) United States
(12) Patent Application Publication
(10) Pub. No.: US 2025/0242301 A1
(43) Pub. Date: Jul. 31, 2025

(54) System and Method of Treatment of Hydrogen Sulfide Gas Released from a Pipeline or Air Pressure Release Valve

(71) Applicants: SOURCE TECHNOLOGIES, LLC, Lexington, KY (US); Streamline Innovations Inc, San Antonio, TX (US)

(72) Inventors: Loren Martz, Lakeland, FL (US); Peter J. Photos, Boerne, TX (US)

(73) Assignees: SOURCE TECHNOLOGIES, LLC, Lexington, KY (US); Streamline Innovations Inc, San Antonio, TX (US)

(21) Appl. No.: 18/428,116

(22) Filed: Jan. 31, 2024

(51) Int. Cl. B01D 53/52; B01D 53/78; B01D 53/96

(52) U.S. Cl. CPC B01D 53/52; B01D 53/78; B01D 53/96; B01D 2257/304; B01D 2258/05; B01D 2259/45

(57) ABSTRACT

A device for treating an influent gas stream contaminated with hydrogen sulfide (H₂S) may include a vessel with an interior chamber. An aqueous metal chelant may be in the chamber, and the aqueous metal chelant may be a standing liquid entirely constrained within the vessel by the sidewall. A gas distribution element including perforations may be connected to an inlet of the vessel. The perforations may be submersed in the aqueous metal chelant so that gas moves through the aqueous metal chelant.

### BACKGROUND OF THE DISCLOSURE

### 1. Field of the Invention

The present invention relates to a system and method of decreasing the concentration of hydrogen sulfide (H₂S) in a gas stream released from a pipeline or an apparatus of a sewage treatment system (“STS’) in which H₂S gas flows and/or accumulates and thus, decreasing the negative health and environmental effects and noxious odor of air contaminated with an H₂S release from a STS. More specifically, it relates to the use of collecting and treating gas released directly from STS pipelines or an air release valve (“ARV”) for the reduction and/or treatment of hydrogen sulfide in the released gas stream.

### 2. Description of the Related Art

The release of H₂S into atmospheric air is a major problem for odor producers around the world. H₂S is a colorless gas that has a foul odor (rotten egg smell) and is slightly heavier than air. Human exposure to small amounts of H₂S in air can cause headaches, nausea, and eye irritation. Higher concentrations can cause respiratory system paralysis, resulting in fainting and possible death. Due to both the noxious odor and negative health effects of H₂S, treatment of a gas contaminated with H₂S occurs prior to discharge of the gas into the atmosphere.

H₂S contamination of oxygenated gas generally results from bacterial anaerobic digestion of organic material. As a result, common sources of malodorous air contaminated with H₂S are sewage treatment systems (STSs). Commonly, the H₂S contaminated gases accumulate and may become trapped in the sewer pipelines. As the H₂S contaminated gases accumulate in a pipe, the gas pressure inside the pipe increases and negatively affects the flow of wastewater with the sewer piping system.

To relieve pressure in the sewer pipes, a pipeline may be equipped with a gas or air release valve (“ARV”) that is triggered by pressure increases within the pipe. When the pressure hits a preset pressure threshold, the ARV releases the H₂S contaminated gases, which generally include oxygen from the STS, above ground to the atmospheric air near the ARV. Thus, the H₂S contaminated gases and their corresponding negative health effects and foul odor are released into the environment.

Current systems for treating oxygenated gas contaminated with H₂S are described in both U.S. Pat. Nos. 10,835,860 B2 and 10,639,585 which are entitled, “Treatment of Hydrogen Sulfide Gas Under Aerobic Conditions” and incorporated herein by reference in their entirety. Other systems for treating oxygenated gas contaminated with H₂S are described in U.S. patent application Ser. No. 18/478,351 entitled, “System and Method of Treatment of Gas Contaminated with Hydrogen Sulfide and the Reduction of Hydrogen Sulfide Associated Odor.” These systems are designed for treating relatively large flow quantities of H₂S contaminated gas, such as H₂S contaminated air, by contacting the contaminated gas with a recirculated aqueous solution of a reagent such as ferric-methyglycinediacetate (F-MGDA). For example, U.S. Pat. Nos. 10,835,860 B2 and 10,639,585 disclose bubbling the contaminated gas through tall column contactors with or without media and U.S. patent application Ser. No. 18/478,351 discloses using an eductor to contact the contaminated gas with F-MGDA. The use of the tall bubble column involves both initial capital expenses to build the tall column as well as a blower powerful enough to force the contaminated air through the column and a pump for reagent recirculation. On the other hand, the use of the eductor requires initial capital expenses for the eductor and a pump to recirculate the reagent. In both cases, ongoing operational expenses occur due to the electricity required to operate the blower or pump(s) as well as the cleaning costs associated with solids build up and fouling of the media, if applicable.

As a result, there is a need for a method of treating oxygenated gas contaminated with H₂S that requires low initial capital expenses, lower operational costs, and less system down time.

### BRIEF SUMMARY OF THE DISCLOSURE

A gas treatment unit, according to this disclosure, allows for treatment of gas released from a pipeline without a blower or pump or contacting tower. Rather, the force of the gas as it is released from the pipeline is enough energy for the gas to move through an aqueous metal chelant in a treatment unit. Further, in applications related to releases of sewer gas from pipelines, the sewer gas is oxygenated which allows for auto regeneration of the aqueous metal chelant.

In some aspects, the techniques described herein relate to a gas treatment unit for treating an influent gas. The gas treatment unit including: a vessel including a sidewall defining a chamber inside the vessel; an aqueous metal chelant in the chamber of the vessel, the aqueous metal chelant being a standing liquid constrained within the vessel by the sidewall, the aqueous metal chelant including a top surface; an inlet in the sidewall, the inlet configured to receive the influent gas into the chamber; and a gas distribution element connected to the inlet, the gas distribution element including perforations positioned below the top surface of the aqueous metal chelant.

In some aspects, the techniques described herein relate to a gas treatment unit, further including: a gas release valve including a gas release valve outlet and a gas release valve inlet, the gas release valve inlet connected to a pipeline; and a fluid conduit including a first end and a second end, the first end connected to the gas release valve outlet and the second end connected to the inlet of the vessel.

In some aspects, the techniques described herein relate to a gas treatment unit further including: a connection between a pipeline and the inlet, the connection allowing the influent gas to flow from a pipeline into the inlet of the vessel.

In some aspects, the techniques described herein relate to a gas treatment unit further including: a vent in the vessel, the vent configured to release a treated gas from the vessel.

In some aspects, the techniques described herein relate to a gas treatment unit, further including: a sulfur settlement zone with the chamber, the sulfur settlement zone below the gas distribution element.

In some aspects, the techniques described herein relate to a gas treatment unit, wherein the aqueous metal chelant further includes: a metal chelant, metal chelants, ferric salts, ferrous salts, ferric chelants, ferrous chelants, nano-iron, colloidal iron, Fe-MGDA, or any combination thereof.

In some aspects, the techniques described herein relate to a gas treatment unit, further including: a downcomer including one end connected to the inlet and a downstream end connected to the gas distribution element.

In some aspects, the techniques described herein relate to a method of treating an influent gas; the method including: constraining an aqueous metal chelant in a vessel such that the aqueous metal chelant is a standing liquid; receiving, in the vessel, an influent gas stream including hydrogen sulfide and oxygen; and contacting, in the vessel, the influent gas stream with and the aqueous metal chelant.

In some aspects, the techniques described herein relate to a method, further including: allowing elemental sulfur to settle at a bottom sidewall of the vessel.

In some aspects, the techniques described herein relate to a method, wherein receiving, in the vessel, the influent gas stream including hydrogen sulfide and oxygen further includes: receiving the influent gas stream from a pipeline.

In some aspects, the techniques described herein relate to a method, wherein receiving, in the vessel, the influent gas stream including hydrogen sulfide and oxygen further includes: receiving the influent gas stream from an air release valve.

In some aspects, the techniques described herein relate to a method, wherein receiving, in the vessel, the influent gas stream including hydrogen sulfide and oxygen further includes: receiving the influent gas stream from a pipeline.

In some aspects, the techniques described herein relate to a method, further including: producing thiosulfate within the vessel.

In some aspects, the techniques described herein relate to a method further including: releasing a treated gas stream from the vessel, the treated gas stream including a lower concentration of hydrogen sulfide than the influent gas.

In some aspects, the techniques described herein relate to a method further including: providing an aqueous metal chelant including a metal chelant, metal chelants, ferric salts, ferrous salts, ferric chelants, ferrous chelants, nano-iron, colloidal iron, Fe-MGDA, or any combination thereof; and placing the aqueous metal chelant in the vessel.

In some aspects, the techniques described herein relate to a method wherein contacting, in the vessel, the influent gas stream with and the aqueous metal chelant further includes: dispersing the influent gas into the aqueous metal chelant using a gas distribution element including perforations submersed in the aqueous metal chelant.

In some aspects, the techniques described herein relate to a gas treatment unit for treating an influent gas. The gas treatment unit including: a vessel including a sidewall defining a chamber inside the vessel; an aqueous metal chelant in the chamber of the vessel, the aqueous metal chelant being a standing liquid constrained within the vessel by the sidewall, the aqueous metal chelant including a top surface; an inlet in the sidewall, the inlet configured to receive the influent gas into the chamber; and a downcomer connected to the inlet, the downcomer including an opening positioned below the top surface of the aqueous metal chelant.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1A is a perspective view of a gas treatment unit, according to this disclosure;

FIG. 1B is a perspective view of a second embodiment of a gas treatment unit, according to this disclosure;

FIG. 2 is a perspective view of a third embodiment of a gas treatment unit, according to this disclosure;

FIG. 3 is side view of the embodiment of the gas treatment unit of FIG. 1 attached, according this embodiment, to an ARV;

FIG. 4 is a side view of an embodiment, according to this disclosure, of the gas treatment unit of FIG. 1 attached to a pipeline;

FIG. 5 is a side view of a fourth embodiment of the gas treatment unit attached to a pipeline;

FIG. 6 is the gas treatment unit if FIG. 1 including a polishing or second stage treatment unit according to this disclosure;

FIG. 7 is a flow diagram of a method, according to this disclosure, of treating a gas stream released from an ARV; and

FIG. 8 is a flow diagram of a method, according to this disclosure, of making the gas treatment unit of FIGS. 1A, 2 and 5.

### DETAILED DESCRIPTION OF THE DISCLOSURE

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. As used herein, the words “connected” or “coupled” are each intended to include integrally formed members, direct connections between two distinct members without any other members interposed therebetween and indirect connections between members in which one or more other members are interposed therebetween. The terminology includes the words specifically mentioned above, derivatives thereof, and words of similar import.

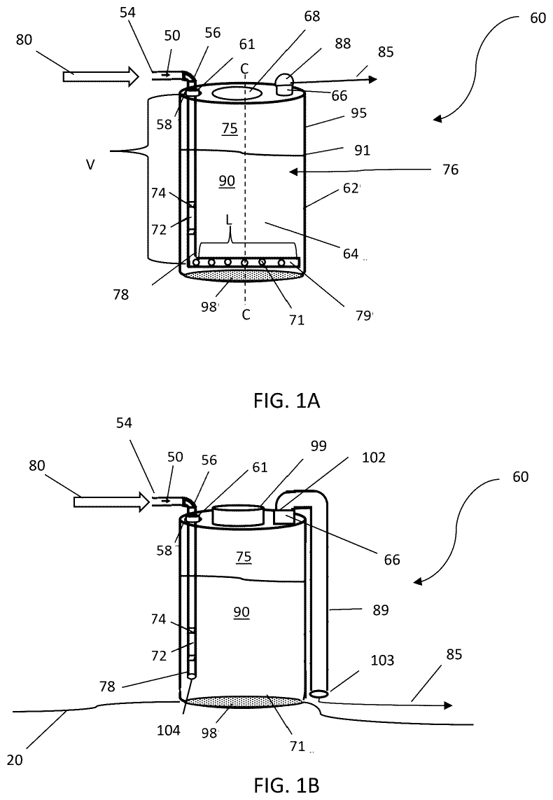

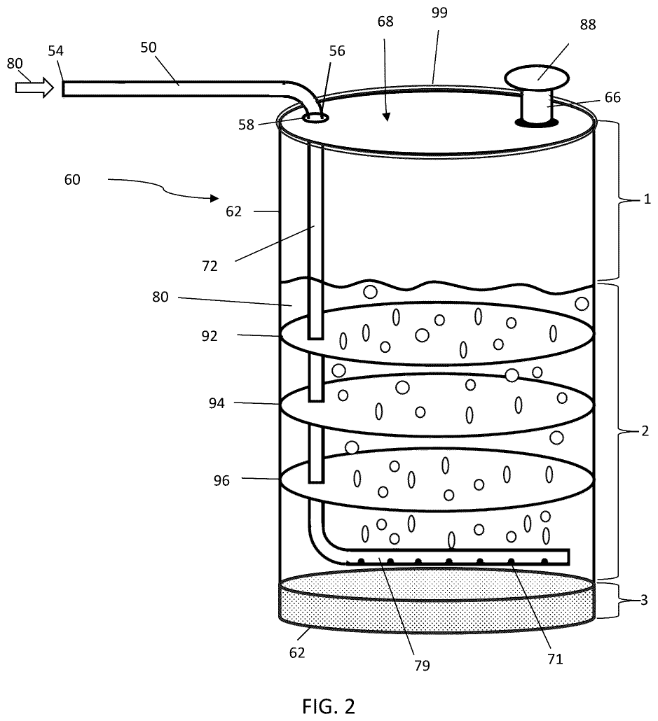

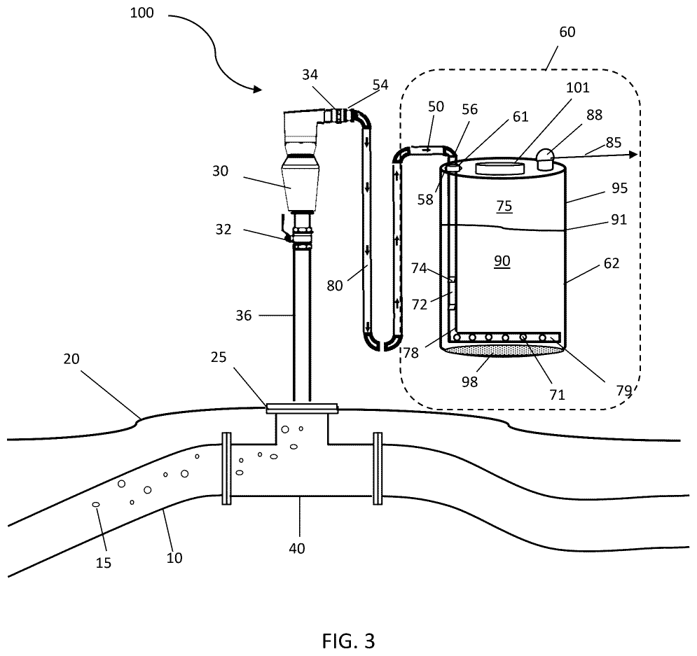

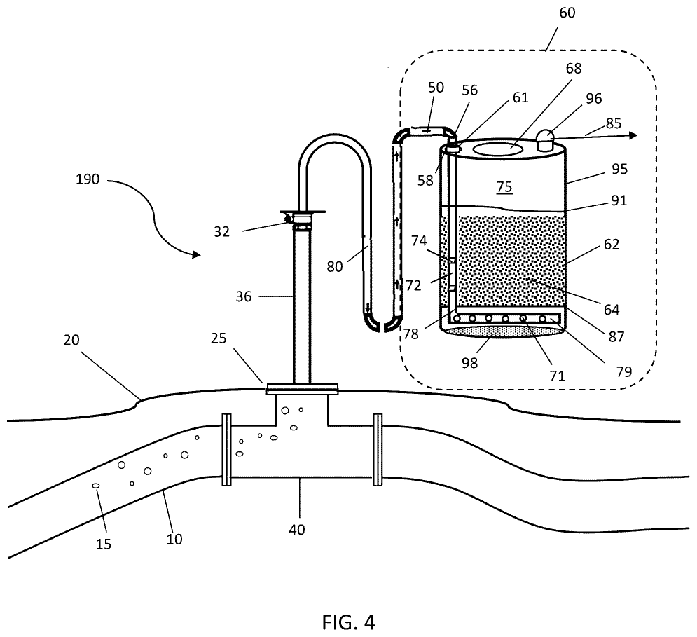

Referring now to the figures in detail, where like numbers are used to indicate like elements throughout, there is shown in FIGS. 1A, 1B and 2 a gas treatment unit 60 for purification or treatment of an influent gas stream 80 such as an oxygenated gas stream contaminated with H₂S released from a sewer pipeline. Unit 60 may include a vessel 95, aqueous metal chelant 90, conduit 50 for connecting to a gas source and the vessel 95, a dowcomer 72 and a distribution element 79. As shown in FIG. 3 unit 60 may be directly connected to an ARV 30. Alternatively, as shown in FIG. 4, unit 60 may be directly connected to pipeline 10. While this disclosure discussed the use of unit 60 for treatment of sewer pipeline oxygenated gases containing H₂S, unit 60 may be utilized to treat H₂S in gases, with or without oxygen, generated from a variety of sources such as STS tanks, industrial wastewater, consumer septic, high-volume facilities with bathrooms (stadiums, parks, etc.) and standalone septic commercial systems, etc.

Gas stream 80 is formed from gas 15 that has accumulated in sewer pipeline 10 and released, via ARV 30. As stream 80 is produced in sewer pipeline 10, stream 80 may be an oxygenated stream contaminated with H₂S. Rather than allowing stream 80 to be released directly to the atmosphere, fluid conduit 50 transports stream 80 to gas treatment unit 60 for treatment.

Vessel 95 is tubular, has a vertically extending centerline C-C and includes a sidewall 62 defining an interior chamber 76, inlet 61, vent 66, opening 68. Chamber 76 holds the aqueous metal chelant 90. Inlet 61 provides an environmentally sealed fitting for fluid conduit 50 to connect to vessel 95. Vent 66 allows treated gas stream 85 to be released to the atmosphere. Opening 68 provides access to the interior chamber 76 for sulfur removal and removal, refreshing and/or addition of the aqueous metal chelant 90.

Preferably, opening 68 includes a cover 99 (FIG. 1A), and vent 66 includes cover 88. The covered opening 68 and vent 66 may reduce or prevent environmental changes such as dilution of the aqueous metal chelant 90 due to atmospheric precipitation or evaporation of chelant 90 due to high temperatures. While cover 99 may seal opening 68 to prevent environmental changes within vessel 95, cover 88 allows vent 66 to remain open to the atmosphere such that treated gas stream 85 may be released.

As shown in FIG. 1B, unit 60 may include a vent conduit 89 connected to vent 66. The vent conduit 89 may extend between first end 102 and a second end 103. The first end 102 is connected to vent 66 and the second end 103 may be positioned at a point substantially lower than the first end 102 and close to the ground. The positioning of second end 103 close to the ground allows any treated gas stream 85 released from vent conduit 89 to remain close to the ground so any remaining de minims odor in the gas is much less likely to be detected. It is noted that odors may result from sewer gas from causes other than H₂S that is effectively treated by unit 60.

Inlet 61 may include downcomer 72 which is a conduit extending downwardly into chamber 76 for dispersal of stream 80 into the aqueous metal chelant 90. Downcomer 72 includes one end 58 connected to fluid conduit 50 at inlet 61 and a submersed or downstream end 78 extending to a point below the top surface or level 91 of the aqueous metal chelant 90. Also, downcomer 72 extends a length V between end 58 and end 78. As shown in FIG. 1B the submersed end 78 may include an opening 104 that allows for dispersal of stream 80 into the aqueous metal chelant 90.

To further increase the contact of stream 80 with the aqueous metal chelant 90, downcomer 72 may include one or more slots 74 along the portion of downcomer 72 submersed in the aqueous metal chelant 90. Slots 74 allow for the release of gas stream 80 along the length V of downcomer 72. Further, a gas distribution element 79 may be attached to submersed end 78.

Chamber 76 includes multiple zones 1, 2, 3. Sulfur settlement zone 3 is located at the lower most portion of chamber 76 and below distribution element 79 and above bottom sidewall 62 of chamber 76. As elemental sulfur 98 is formed in vessel 95, the sulfur 98 settles to zone 3. This zone may also include aqueous metal chelant 90. Zone 2 is above zone 3 and includes chelant 90. Further, zone 2 may include sulfur 98 suspended in chelant 90. Zone 1 may be a height of space 75 above chelant 90 in which treated gas stream 85 may reside before moving through vent 66. Further, if the pressure in zone 3 is equal to atmospheric pressure, atmospheric air may move into zone 3 via vent 66.

As shown in FIG. 2, gas distribution element 79 may include perforations 71 and may extend inwardly and/or horizontally at an angle relative to downcomer 72. That is, element 79 may extend horizontally, entirely across the width of chamber 76 or a portion thereof. Perforations 71 along the length L of element 79 allow stream 80 to be dispersed in a wider range than submersed end 78. That is, element 79 may include a greater width than downcomer 72. Element 79 may be a horizontally extending conduit with perforations 71, bubbler, diffuser, sparger, or any other suitable gas distribution device.

The aqueous metal chelant 90 is a static or non-recirculated reducing agent stream. More specifically, the aqueous metal chelant 90 is a standing liquid that is passive and without motive force. Opening 68 is the only access provided for changing or recharging of chelant 90 and opening 68 remains closed during operation of unit 60. Therefore, chelant 90 is entirely constrained by chamber 76. As shown in FIGS. 1A, 1B and 2, opening 68 may be of differing sizes. For example, in FIG. 2 opening 68 and cover 99 are wide enough to be able to service diffusion plates 92, 94, 96. On the other hand, in FIGS. 1A and 1B, opening 68 and cover 99 are relatively smaller.

Aqueous metal chelant 90 may include an aqueous solution of metal chelant or metal chelants such as one or more of ferric salts, ferrous salts, ferric chelants, ferrous chelants, nano-iron, colloidal iron, tetrasodium glutamate diacetate (“GLDA”), Fe-MGDA (ferric/ferrous methylglycinediacetate), Alanine, n,n-bid, (carboxymethyl) iron complex (CAS 547763-83-7).

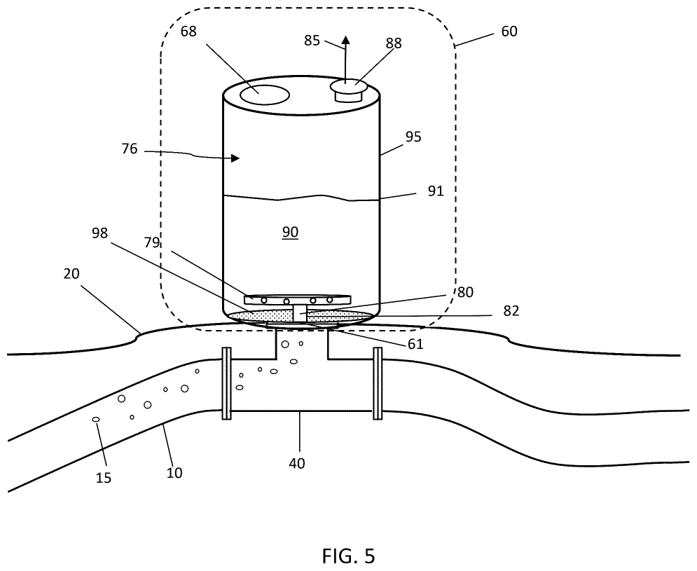

As shown in FIGS. 1A-4, fluid conduit 50 includes first end 54 and a second end 56 with a length extending therebetween. The first end 54 is a reciprocal end configured for connection to a source of contaminated gas stream 80 such as an ARV outlet 34 or an outlet sewer pipeline outlet 25. Second end 56 is connected to inlet 61 of vessel 95. The connections of conduit 50 between inlet 61 and outlet 34 or outlet 25 are environmentally sealed such that fluid conduit 50 provides environmentally sealed transportation of stream 80 to vessel 95. Although conduit 50 is shown in FIGS. 1A-4, other methods of sealed stream 80 transport may be utilized such as a direct connection of vessel 95 to pipeline 10 or ARV 30 without conduit 50. For example, as shown in FIG. 5, gas treatment unit 60 includes vessel 95 with inlet 61 on the bottom rather than the top as shown in FIGS. 1A-4. In this configuration, inlet conduit 82, rather than downcomer 72, transfers gas stream 80 into metal chelant 90. A gas distribution element 79 as shown or discussed above may be used to distribute influent gas stream 80 across the width of chamber 76.

Treatment unit 60 may include mechanical features to assist in contacting between the metal chelant 90 and the influent gas stream 80. For example, as shown in FIG. 2, one or more diffusion plates 92, 94, 96 may be added to promote contact between the aqueous metal chelant 90 and bubbles of gas stream 80. The diffusion plates 92, 94, 96 include fine perforations. Bubbles of gas stream 80 move upwardly through the aqueous metal chelant 90 and impact plate(s) 92. 94, 96. Then, the plate(s) 92, 94, 96 force the bubbles to reduce in size and/or change shape for transmission through plate(s) 92, 94, 96. Further, plate(s) 92, 94, 96 slow the movement of the gas bubbles through the aqueous metal chelant 90. Also, as shown in FIG. 4, packing media 64 may be placed in vessel 95. Preferably, the media 64 may be held in place by a horizontally extending support 87 such that the packing media 64 is held above element 79 and sulfur 98 settling zone 3. Support 87 may rest on the bottom of vessel 95 or be connected to the sidewall 62. Alternatively, the media 64 may simply rest on the bottom of vessel 95.

As shown in FIG. 3, gas treatment system 100 may include ARV 30 and unit 60. ARV 30 includes an inlet 32 and an outlet 34. Inlet 32 is connected to sewer pipeline 10 via opening 25 in sewer junction 40 and pipeline conduit 36. The outlet 34 is connected to fluid conduit 50. The ARV 30 may be above or below ground level 20. Gas 15 which has accumulated in pipeline 10 may flow upwardly from pipeline 10 into pipeline conduit 36 and ARV 30 via inlet 32. When the pressure at the ARV 30 exceeds a preset threshold such as 2-5 atmospheres of pressure, ARV 30 automatically releases gas stream 80 from the ARV outlet 34.

ARV 30 may be any type of pressure relief valve applicable for gas release from a pipeline, tank or any other conduit or container. For example, the ARV 30 may also include an air/vacuum valve or combination air-release and air/vacuum valve, etc.

As shown in FIG. 4, unit 60 may be directly connected to sewer pipeline 10 via outlet 25 and conduit 50. As long as opening 25 is positioned on an upper portion of the pipeline 10, sewer gas may form bubbles 15 that move upwardly and out of pipeline 10 via opening 25. As the bubbles 15 release the sewer gas, gas stream 80 is formed and may move directly into unit 60 via conduit 50. Without ARV 30 disposed between pipeline 10 and unit 60, stream 80 may move from pipeline to unit 60 continuously as long as the gas pressure exceeds atmospheric pressure. When the pressure does not exceed atmospheric pressure, gas stream 80 will be intermittent. That is, stream 80 will start and stop based on whether or not the gas pressure within the pipe exceeds atmospheric pressure.

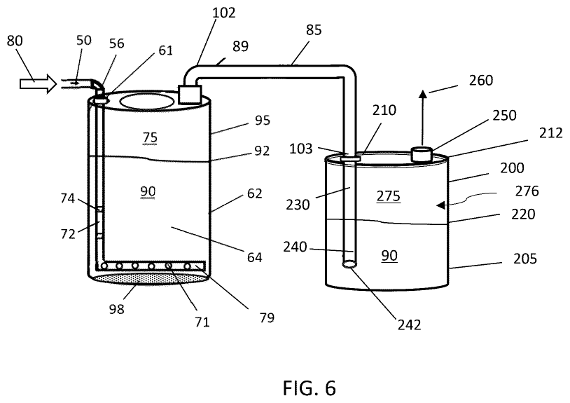

As shown in FIG. 6, a polishing or second stage treatment unit 200 may be connected downstream of unit 60. Unit 200 may be utilized in different situations such as when the H₂S concentration of the influent gas stream 80 exceeds the treatment capacity of unit 60 and/or there are surges of influent gas in excess of the treatment and/or volumetric capacity of unit 60.

Unit 200 may include a tubular chamber 276 defined by sidewall 205. Unit 200 may also include a vent 250 and inlet 210. Chamber 276 includes empty space 275 as well as aqueous metal chelant 90, which is standing solution or liquid. Inlet 210 may include a downcomer 230 with an end 240 submersed below the chelant level 220. Further, the submersed end 240 may include opening 242 for release of the influent gas stream 85 into the chelant 90 within unit 200.

Units 200 may be connected downstream of unit 60 via vent conduit 89 with first end 102 connected to vent 66 and the second end 103 connected to inlet 210. Gas stream 85 moves from the vent 66 and through vent conduit 89 into unit 200. Unit 200 releases treated stream 260 from vent 250.

It is noted that the size of the polishing unit 200 may vary based on the treatment needs. Generally, unit 200 may be relatively smaller than unit 60. Also, inlet 210 may also vary. Although downcomer 230 is shown in FIG. 6, downcomer 230 may or may not be required and the inlet 210 may simply release the gas into the empty space 275.

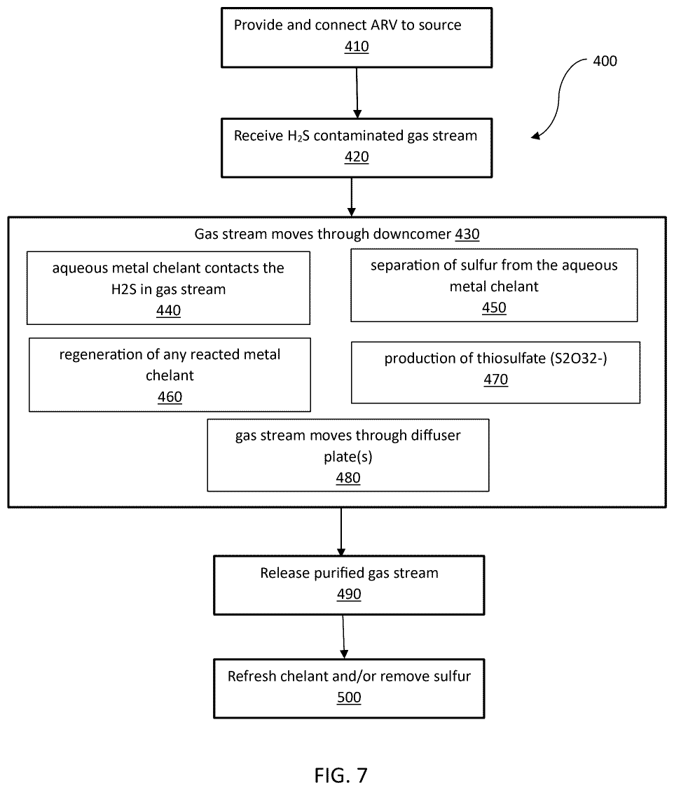

A flow diagram of method 400 for treating gas contaminated with H₂S is provided in FIG. 7. Initially, in step 410, gas treatment unit 60 is provided and connected to a source of H₂S contaminated gas stream 80. As discussed above, the source may be STS pipeline 10 or ARV 30 attached to pipeline 10. Also, this step includes the aqueous metal chelant 90 being provided entirely contained within chamber 76. Next, in step 420, gas stream 80 is received by unit 60 through inlet 61. Gas stream 80 includes gas that has accumulated in pipeline 10 and may be passively released when the pressure of the gas exceeds atmospheric pressure. If an ARV 30 is utilized, ARV 30 releases gas stream 80 when the pressure of the gas within pipeline 10 exceeds the predetermined pressure threshold of ARV 30.

Next, in step 430, gas stream 80 travels through downcomer 72 into chamber 76, and gas stream 80 is released into aqueous metal chelant 90. Gas stream 80 may enter the aqueous metal chelant 90 via an opening on submersed end 78 of downcomer 72. Additionally, if downcomer 72 includes slots 74 and/or gas distribution element 71, gas stream 80 may enter chelant 90 via slots 74 and/or perforations 71 in element 79.

As gas stream 80 is released into chamber 76, stream 80 bubbles through chamber 76, with or without media 64 or plate(s) 92, 94, 96, and multiple activities may be performed by vessel 95. In step 440, the aqueous metal chelant 90 contacts the H₂S in gas stream 80, and the sulfide ions in the H₂S combine to form sulfur 98 while the metal is reduced. For example, when an iron chelate is used as the reducing agent, a reduction reaction occurs as follows:

Reduction: H₂S(g)+2Fe³⁺(aq)→2H⁺(aq)+S(s)+2Fe²⁺(aq).

As result, of this reaction, elemental sulfur 98 precipitates within chamber 76 and the metal chelant becomes unavailable for further reaction. Further, purified gas stream 85 may be released to the atmosphere via vent 66. The treated gas stream 85 includes purified air with a lower H₂S concentration, as compared to the influent gas stream 80, and reduced or little to no odor caused by H₂S.

In step 450, vessel 95 also allows for the separation of sulfur from the aqueous metal chelant 90. Initially, sulfur 98 is suspended in the aqueous metal chelant 90, but over time sulfur 98 settles on the bottom sidewall of chamber 76.

Another activity that may occur within vessel 95 includes regeneration of any reacted metal chelant(s) during step 460. The oxygen in stream 80 allows for the reduction oxidation (“redox”) reactions to occur simultaneously within chamber 76. The regeneration of the unavailable metal chelant occurs through an oxidation reaction in which the oxygen in stream 80 acts as the oxidizer. Assuming the reducing agent is an iron chelate, the oxidation reaction would be as follows:

Oxidation: 2H⁺(aq)+2Fe²⁺(aq)+0.5O₂(g)→2Fe³⁺(aq)+H₂O(l).

Thus, the unavailable metal chelant is oxidized to return to available metal chelant for reuse within chamber 76.

Step 470 is another possible activity within vessel 76 and includes the production of thiosulfate (S₂O₃²⁻). An oxygen enriched stream, such as the influent gas stream 80, may react with sulfide ions in an alkaline solution to produce thiosulfate (S₂O₃²⁻). Initially, this reaction will create sulfite ions. These ions are reducing and may react with monoatomic sulfur producing thiosulfate as a result. The reaction may proceed as follows:

First Step: OH⁻+HS⁻+0₂→SO3²⁻+2H⁺

Second Step: S₀+SO3²⁻→S₂O₃²⁻

Step 480 is another activity that may occur within chamber 76. Gas stream 80 may bubble through one or more diffuser plates 92, 94, 96 which may promote increased contacting by slowing the upward movement of gas stream 80. Also, as gas stream 80 passes through plate(s) 92, 94, 96, the size and shape of the bubbles may change so as to increase the degree of contacting within chamber 76.

Step 490 includes releasing a purified gas stream 85 via vent 66. Since the H₂S has been removed or reduced from gas stream 85, stream 85 may be safely released to the atmosphere.

Step 500 includes maintaining chamber 76 in condition for continued use. For example, as sulfur 98 and thiosulfate (S₂O₃²⁻) accumulate within chamber 76, the amount of available metal chelant decreases. Therefore, periodically, sulfur 98 must be removed from chamber 76 via opening 68, and the aqueous metal chelant 90 must be refreshed by adding new or regenerated chelant 90. Further, the entire contents of chamber 76 may be removed via opening 68 and a new supply of chelant 90 may be added.

Steps 440-480 are shown within step 430 of FIG. 6 because one or more of these steps as well as step 490 may occur simultaneously.

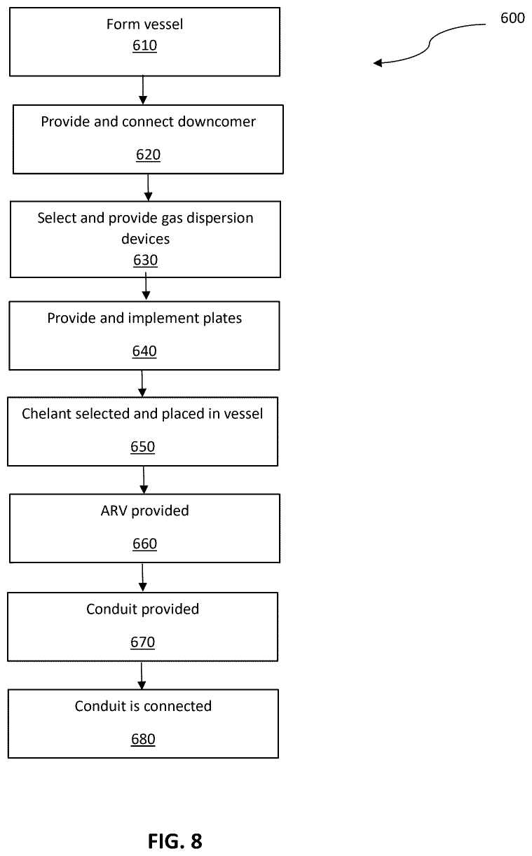

FIG. 8 is a flow chart of method 600 of making system 100 for treatment of oxygenated gas contaminated with H₂S. Initially, in step 610, unit 60 is formed. Vessel 95, as discussed above, may be formed of environmentally and H₂S impermeable substance such as stainless steel, metal, metal alloys, fiberglass, plastics, etc. Also, vessel 95 is shown as cylindrical with hollow interior chamber 76. However, vessel 95 may be of various tubular shapes (i.e. cylindrical, cube, rectangular, etc.) with a sidewall 62 that completely encloses chamber 76 with the exception of inlet 61, opening 68 and vent 66.

The size of chamber 76 may be determined based on the H₂S concentration within influent gas stream 80, the pressure of influent gas stream 80, the H₂S target level after treatment and empty space 75. For odor control, the target level may be between 1-5 ppm in gas stream 85 which is released to the environment. For example, for an influent gas stream 80 at a minimum pressure of 1 PSI with an H₂S concentration of 25 ppm and an outlet H₂S target level of <4 ppm H₂S, 26 inches of metal chelant may be required. Also, for an influent gas stream 80 at minimum pressure of 1.3 PSI with an H₂S concentration of 10 ppm and an outlet H₂S target level of <1 ppm H₂S, 33 inches of metal chelant may be required.

To accommodate gas stream 80 surge into chamber 76, a volume of empty space 75 is required above the metal chelant 90. When the gas enters chamber 76, there is a surge that increases the total volume of the contents (i.e. gas stream 80 and chelant 90) within chamber 76. As a result, a volume of empty space 75 must be provided in chamber 76 above the metal chelant 90.

Inlet 61 should be formed with the ability to provide an environmentally sealed connection between the conduit 50 and vessel 95. For example, inlet 61 may include a threaded compression fitting such as bulkhead fitting or any other suitable fitting such as a slip to provide the environmentally sealed connection.

In step 620, downcomer 72 may be provided and connected to inlet 61. Downcomer 72 may be a length V of a pipe, tubing, or other suitable gas transportation device. Also, downcomer 72 may be formed of environmentally and H₂S impermeable substance such as stainless steel, metal, metal alloys, fiberglass, plastics, etc. The length of downcomer 72 must be long enough to penetrate into chamber 76 such that open end 78 is below the level 91 of aqueous metal chelant 90. The connection of downcomer 72 to vessel 95 may be made via reciprocal threaded connectors on inlet 61 and end 58, an adhesive or epoxy resin and/or press fit of end 58 into inlet 61.

In step 630, gas dispersion devices for releasing the gas in the aqueous metal chelant 90 are selected and implemented. Downcomer 72 may include an opening at the submersed end 78. If greater contacting is desired, a gas distribution element 79 may be connected to submersed end 78.

In step 640, further gas/liquid contacting enhancements may be added. For example, one or more plates 92, 94, 96 may be connected to downcomer 72 and or sidewall 62. The plates may be formed of materials such as stainless steel and/or plastic with various sized holes. Examples of packing media 64 include multi-faceted balls or other suitable 3-dimensional shapes and the media 64 may also be formed of materials such as stainless steel and/or plastics. Also, a combination of plate(s) 92, 94, 96 and packing media 64 may be utilized with the lower most plate 96 acting as support 87. If the packing media 64 is utilized without plate 96, a suitable support 87 may be formed of a barrier strong enough to hold the media 64 but also includes slots or holes through which the chelant 90, gas stream 80 and sulfur 98 may pass. The support may be connected to the sidewall 62 and/or the downcomer 72 and also formed of a material such as stainless steel, plastics, or fiberglass, etc.

In step 650, the aqueous metal chelant 90 is provided. A desired metal chelant is selected, and an aqueous solution is prepared including the selected metal chelant. Next, the aqueous metal chelant 90 may be placed, via opening 68, in chamber 76. Level 91 and corresponding volume of chelant 90 in unit 60 may be set as described in step 610.

In step 660, if desired, an ARV 30 is provided and connected to pipeline 10 such that ARV 30 may receive and transmit gas from within the pipeline 30. ARV inlet 32 may be connected directly to opening 25 of junction 40. Alternatively, pipeline conduit 36 may be connected between opening 25 and ARV inlet 32. The connections should be environmentally sealed methods.

In step 670, fluid conduit 50 is provided. The conduit may be made of an environmentally and H₂S impermeable substance such as stainless steel, metal, metal alloys, fiberglass, plastics, etc. Further, conduit 50 includes first end 54 with complementary fitting for connection to ARV outlet 34 or opening 25 of junction 40 and a second end 56 for connection with a fitting at inlet 61. Examples of the complementary fittings include threaded fittings for connection with the bulkhead fitting at inlet 61 and connection to the ARV outlet 34 which may be a male threaded connection. Other suitable connection fittings such as slip, press fit and/or welded connections may also be utilized.

In the case that an ARV 30 is not utilized, the first end 54 of conduit 50 may be connected directly to pipeline 10. For example, opening 25 of junction 40 may be equipped with an environmentally sealed fitting such as a bulkhead fitting, for connection with the first end 54.

In step 680, first end 54 of conduit 50 is connected to the source of gas stream 80. If ARV 30 is in use, the first end 54 is connected directly to ARV outlet 34, opening 25 or pipeline conduit 36. Also, the second end 56 of conduit 50 is connected to inlet 61. Polytetrafluoroethylene (PTFE) tape may be disposed between the male and female fittings prior to making the connections. These connections should be environmentally sealed to prevent the release of gas stream 80 to the atmosphere before being treated in unit 60.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A gas treatment unit for treating an influent gas, the gas treatment unit comprising:
a vessel including a sidewall defining a chamber inside the vessel;
an aqueous metal chelant in the chamber of the vessel, the aqueous metal chelant being a standing liquid constrained within the vessel by the sidewall, the aqueous metal chelant including a top surface;
an inlet in the sidewall, the inlet configured to receive the influent gas into the chamber; and
a gas distribution element connected to the inlet, the gas distribution element including perforation positioned below the top surface of the aqueous metal chelant.

2. The gas treatment unit of claim 1, further comprising:
a gas release valve including a gas release valve outlet and a gas release valve inlet, the gas release valve inlet connected to a pipeline; and
a fluid conduit including a first end and a second end, the first end connected to the gas release valve outlet and the second end connected to the inlet of the vessel.

3. The gas treatment unit of claim 1 further comprising:
a connection between a pipeline and the inlet, the connection allowing the influent gas to flow from a pipeline into the inlet of the vessel.

4. The gas treatment unit of claim 1 further comprising:
a vent in the vessel, the vent configured to release a treated gas from the vessel.

5. The gas treatment unit of claim 1, further comprising:
a sulfur settlement zone with the chamber, the sulfur settlement zone below the gas distribution element.

6. The gas treatment unit of claim 1, wherein the aqueous metal chelant further comprises:
a metal chelant, metal chelants, ferric salts, ferrous salts, ferric chelants, ferrous chelants, nano-iron, colloidal iron, Fe-MGDA, or any combination thereof.

7. The gas treatment unit of claim 1, further comprising:
a downcomer including one end connected to the inlet and a downstream end connected to the gas distribution element.

8. A method of treating an influent gas; the method comprising:
constraining an aqueous metal chelant in a vessel such that the aqueous metal chelant is a standing liquid;
receiving, in the vessel, an influent gas stream including hydrogen sulfide and oxygen; and
contacting, in the vessel, the influent gas stream with and the aqueous metal chelant.

9. The method of claim 8, further comprising:
allowing elemental sulfur to settle at a bottom sidewall of the vessel.

10. The method of claim 8, wherein receiving, in the vessel, the influent gas stream including hydrogen sulfide and oxygen further comprises:
receiving the influent gas stream from a pipeline.

11. The method of claim 8, wherein receiving, in the vessel, the influent gas stream including hydrogen sulfide and oxygen further comprises:
receiving the influent gas stream from an air release valve.

12. The method of claim 8, wherein receiving, in the vessel, the influent gas stream including hydrogen sulfide and oxygen further comprises:
receiving the influent gas stream from a pipeline.

13. The method of claim 8, further comprising:
producing thiosulfate within the vessel.

14. The method of claim 8 further comprising:
releasing a treated gas stream from the vessel, the treated gas stream including a lower concentration of hydrogen sulfide than the influent gas.

15. The method of claim 8 further comprising:
providing an aqueous metal chelant including a metal chelant, metal chelants, ferric salts, ferrous salts, ferric chelants, ferrous chelants, nano-iron, colloidal iron, Fe-MGDA, or any combination thereof; and
placing the aqueous metal chelant in the vessel.

16. The method of claim 8 wherein contacting, in the vessel, the influent gas stream with and the aqueous metal chelant further comprises:
dispersing the influent gas into the aqueous metal chelant using a gas distribution element including perforations submersed in the aqueous metal chelant.

17. A gas treatment unit for treating an influent gas, the gas treatment unit comprising:
a vessel including a sidewall defining a chamber inside the vessel;
an aqueous metal chelant in the chamber of the vessel, the aqueous metal chelant being a standing liquid constrained within the vessel by the sidewall, the aqueous metal chelant including a top surface;
an inlet in the sidewall, the inlet configured to receive the influent gas into the chamber; and
a downcomer connected to the inlet, the downcomer including an opening positioned below the top surface of the aqueous metal chelant.
